(19) United States
(12) Patent Application Publication
(10) Pub. No.: US 2022/0011093 A1
(43) Pub. Date: Jan. 13, 2022

(54) OPTICAL MEDIA SENSOR WITH BLOWER

(71) Applicant: HEWLETT-PACKARD DEVELOPMENT COMPANY, L.P., Spring, TX (US)

(72) Inventors: Sachiyo YAMADA, Yokohama (JP); Hirokazu YUKAWA, Yokohama (JP)

(73) Assignee: HEWLETT-PACKARD DEVELOPMENT COMPANY, L.P., Spring, TX (US)

(21) Appl. No.: 17/289,111

(22) PCT Filed: Jan. 2, 2020
(86) PCT No.: PCT/US2020/012062

§ 371 Date: Apr. 27, 2021

(30) Foreign Application Priority Data
Jan. 11, 2019 (JP) 2019-003352

(51) Int. Cl. G01B 11/06; G01N 21/57; G01N 21/86; B65H 7/14; B41F 25/00

(52) U.S. Cl. CPC G01B 11/0691; G01N 21/57; G01N 21/86; B65H 2511/13; B41F 25/00; G01N 2021/8663; B65H 2553/414; B65H 7/14

(57) ABSTRACT

An optical media sensor includes a guide wall, a light emitter, a light receiver and a blower. The guide wall has an opening. The light emitter emits light to a medium sheet through the opening. The light receiver detects an amount of light travelling from the medium sheet. The blower generates a wind pressure that presses the medium sheet against the guide wall when detecting the amount of light.

### BACKGROUND

Some optical media sensors include a light emitting part for emitting light to a medium sheet and a light receiving part for detecting an amount of reflected light or transmitted light from the medium sheet. During detection operation, a change in the position or shape of the medium sheet may change the detected amount of light, which may interfere with the accuracy of the light detection. Thus, during detection operation, the medium sheet may be pressed to a guide wall of a conveyance path by physical means such as an elastic film to keep the position or shape of the medium sheet constant.

### BRIEF DESCRIPTION OF DRAWINGS

FIG. 1 is a schematic diagram illustrating a portion of an example imaging apparatus including an example optical media sensor.

FIG. 2A is a schematic diagram of an example optical media sensor, in an operational state.

FIG. 2B is a schematic diagram of the example optical media sensor, in another operational state.

FIG. 2C is a schematic diagram of the example optical media sensor, in another operational state.

FIG. 2D is a schematic diagram of the example optical media sensor, in another operational state.

FIG. 3A is a schematic diagram of an example optical media sensor, in an operational state.

FIG. 3B is a schematic diagram of the example optical media sensor, in another operational state.

FIG. 4A is a schematic diagram of an example optical media sensor, in an operational state.

FIG. 4B is a schematic diagram of the example optical media sensor, in another operational state.

FIG. 5A is a schematic diagram of an example optical media sensor, in an operational state.

FIG. 5B is a schematic diagram of the example optical media sensor, in another operational state.

FIG. 6A is a schematic diagram of an example optical media sensor, in an operational state.

FIG. 6B is a schematic diagram of the example optical media sensor, in another operational state.

FIG. 6C is a schematic diagram of the example optical media sensor, in another operational state.

FIG. 7 is a graph illustrating a relationship between a wind pressure of a blower and a position of a medium sheet in an example optical media sensor.

FIG. 8 is a graph illustrating a relationship between a wind pressure of a blower and a position of a medium sheet in an example optical media sensor.

FIG. 9 is a graph illustrating a relationship between a wind pressure of a blower and an amount of diffused reflected light from a medium sheet in an example optical media sensor.

FIG. 10 is a graph illustrating a relationship between a thickness of a medium sheet and a wind pressure width in an example optical media sensor.

FIG. 11 is a flow chart showing an example process for determining a thickness of a medium sheet by use of an example optical media sensor.

FIG. 12 is a schematic view showing an example imaging apparatus including an example optical media sensor.

FIG. 13 is a flow chart showing an example method for manufacturing an example optical media sensor.

### DETAILED DESCRIPTION

An example optical media sensor may include a first guide wall, a light emitter (also referred to herein as a light emitting section or a light emitting part), a light receiver (also referred to herein as a light receiving section or a light receiving part), and a blower. The first guide wall has a first opening. The light emitter emits light to a medium sheet (e.g., a paper sheet) through the first opening. The light receiver detects an amount of reflected light or transmitted light received from the medium sheet. The blower generates a wind pressure for pressing the medium sheet to the first guide wall at the time of detecting the amount of reflected light or transmitted light.

The blower may generate the wind pressure for pressing the medium sheet to the first guide wall by discharge operation or suction operation.

The optical media sensor may include a sensor housing for accommodating the light emitter and/or the light receiver, and the sensor housing may have a light permeable window facing the first opening of the first guide wall.

The blower may discharge air toward the light permeable window when the medium sheet is absent.

The light emitter and/or the light receiver may be disposed at a predetermined position in the sensor housing, and the optical media sensor may include a spacer between the sensor housing and the first guide wall.

The optical media sensor may include a second guide wall having a second opening facing the first opening, and the medium sheet may be disposed in a conveyance path defined between the first guide wall and the second guide wall.

The blower may be disposed outside the conveyance path and may generate the wind pressure through the first opening or the second opening.

The light receiver may be a light receiver for detecting an amount of reflected light received from the medium sheet, and the optical media sensor may determine a surface characteristic of the medium sheet based on the detected amount of the reflected light.

The light receiver may be a light receiver for detecting an amount of diffused reflected light received from the medium sheet. The blower may generate a wind pressure for moving the medium sheet in the conveyance path toward the first guide wall or the second guide wall through the first opening or the second opening. The optical media sensor may detect the amount of the diffused reflected light from the medium sheet by the light receiver while gradually changing the wind pressure of the blower. The optical media sensor may determine a thickness of the medium sheet based on the wind pressures of the blower when the detected amount of the diffused reflected light reaches upper and lower limits, respectively.

The blower may generate the wind pressure for moving the medium sheet in the conveyance path toward the first guide wall or the second guide wall by discharge operation or suction operation.

The light receiver may be a light receiver for detecting an amount of transmitted light received from the medium sheet, and the optical media sensor may determine a thickness of the medium sheet based on the detected amount of the transmitted light.

The blower may be a piezoelectric blower.

An example imaging apparatus may include the optical media sensor.

An example method for manufacturing an optical media sensor, may include:

forming an opening in a guide wall of a conveyance path for a medium sheet;

disposing a light emitter for emitting light to the medium sheet in the conveyance path through the opening;

disposing a light receiver for detecting an amount of reflected light or transmitted light received from the medium sheet; and

disposing a blower for generating a wind pressure for pressing the medium sheet to the guide wall at the time of detecting the amount of the reflected light or the transmitted light.

In some example methods for manufacturing an optical media sensor, the blower may be a piezoelectric blower.

In the following description, with reference to the drawings, the same reference numbers are assigned to the same components or to similar components having the same function, and overlapping description is omitted.

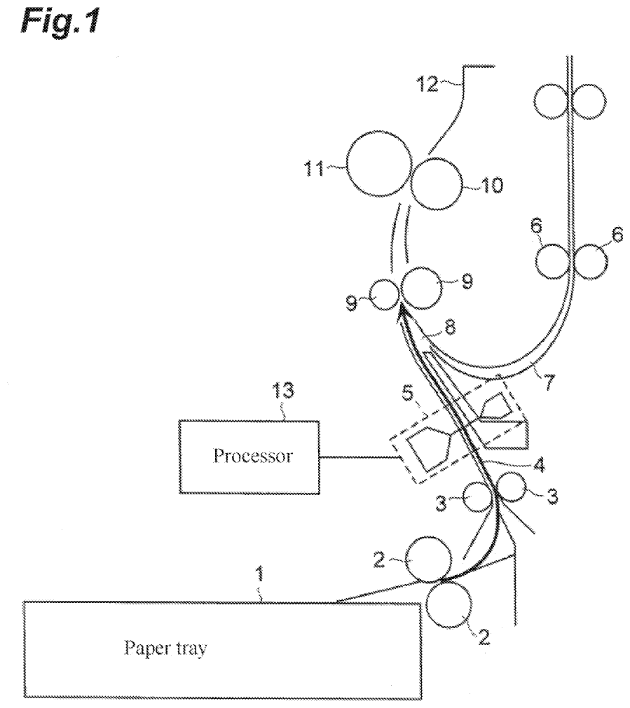

FIG. 1 is a schematic view showing a portion of an example imaging apparatus including an example optical media sensor 5. A medium sheet (e.g., a paper sheet) held in a sheet tray, such as a paper tray 1, is picked up by pick-up rollers 2, and conveyed along a conveyance path 4 to register rollers 9 by feed rollers 3. The register rollers 9 straighten an inclination of the medium sheet, and then, supply the medium sheet to a transfer roller 10. The transfer roller 10 rotates while pressing the medium sheet to a photosensitive drum 11, thereby transferring a toner image on the photosensitive drum 11 onto the medium sheet. The medium sheet having the transferred toner image is thereafter conveyed to a fixing device (not illustrated) through a conveyance path 12. A back-side conveyance path roller 6 is a roller for conveying a printing paper sheet having a print on one side thereof along a conveyance path 7 during printing on both sides. The conveyance path 4 and the conveyance path 7 merge with each other at a merging point 8.

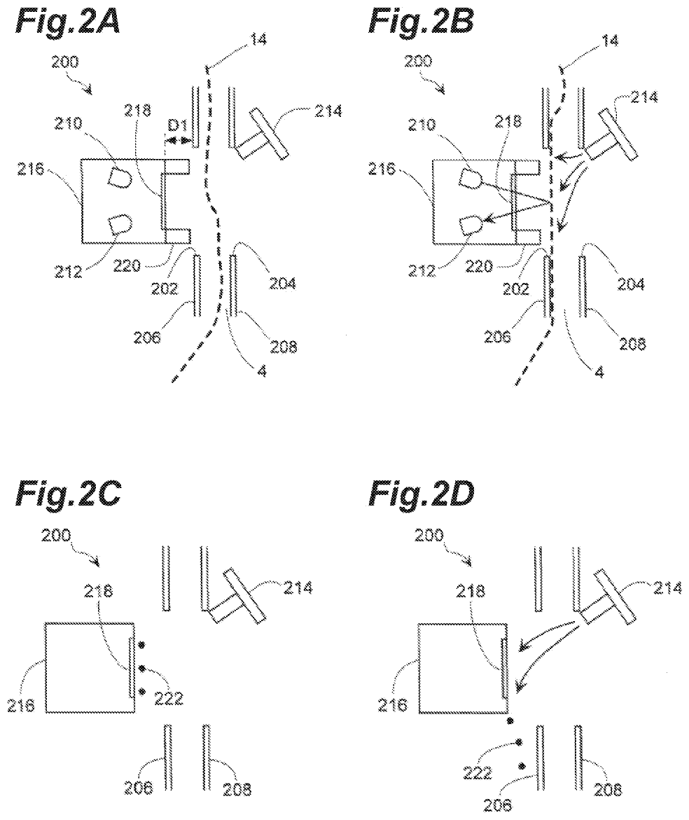

The optical media sensor 5 is disposed near the conveyance path 4 and detects a surface characteristic or a thickness of a medium sheet conveyed on the conveyance path 4. The optical media sensor 5 includes a light emitter for emitting light to a medium sheet and a light receiver for detecting an amount of light travelling from the medium sheet, for example an amount of reflected light or transmitted light received from the medium sheet. The medium sheet may be conveyed with a slight deformation while oscillating in the conveyance path 4. The optical media sensor 5 includes a blower (illustration is omitted) for generating a wind pressure to keep a position or a shape of the medium sheet constant near a detection area at the time of detecting the amount of the reflected light or the transmitted light. The blower will be described in detail later by referring to FIGS. 2A to 6. An analog voltage value indicative of the amount of the reflected light and/or the amount of the transmitted light detected by the light receiver is converted into a digital value by an ND converter (illustration is omitted); and fed to a controller (e.g., processor 13). The processor 13 controls the operation of the light emitter, the light receiver and the blower, and also determines surface characteristics or a thickness of the medium sheet based on the amount of the reflected light and/or the amount of the transmitted light detected by the light receiver. The optical media sensor 5 may include the processor 13.

With reference to FIGS. 2A and 2B, an example optical media sensor 200 may include a first guide wall 206 having a first opening 202, a light emitter 210 for emitting light to a medium sheet 14 (e.g., a paper sheet) through the first opening 202, a light receiver 212 for detecting the amount of the reflected light received from the medium sheet 14, and a blower 214. With reference to FIG. 2A, at the time of non-operation of the optical media sensor 200, the medium sheet 14 may come close to the first guide wall 206 and may be conveyed with a slight deformation. The blower 214 is disposed at the same side as the medium sheet 14 relative to the first guide wall 206 while away from the medium sheet 14. With reference to FIG. 2B, at the time of detecting the amount of the reflected light, the blower 214 generates a wind pressure for pressing the medium sheet 14 to the first guide wall 206. The blower 214 generates this wind pressure by a discharge operation. This allows the medium sheet 14 near a detection area to keep its position or shape constant during detection of the amount of the reflected light, therefore keeping an optical path length and an angle constant. Accordingly, the blower 214 may press the medium sheet 14 to the first guide wall 206 without contacting the medium sheet 14, to protect the medium sheet 14. In one example, the light emitter 210 may include a light emitting diode (LED) as a light-emitting element. The light emitter 210 may include other light-emitting element. The light receiver 212 may include a photodiode (PD) or a phototransistor (PTr) as a light-receiving element. The light receiver 212 may include other light-receiving element. FIG. 2A shows the light receiver 212 for detecting regular reflection light, but the arrangement of the light emitter 210 and the light receiver 212 is not limited to the illustrated arrangement. Depending on the arrangement of the light emitter 210 and the light receiver 212, the light receiver 212 may be a light receiver for detecting diffused reflected light or may be a light receiver for detecting both regular reflection light and diffused reflected light.

The blower 214 may be arranged to generate a wind pressure for pressing the medium sheet 14 to the first guide wall 206. The “blower” may include a device having a function of discharging air and/or a device having a function of sucking air. In some examples, the blower 214 is a piezoelectric blower which may also be referred to as a micro blower, a micro air pump or the like. A piezoelectric blower is a blower wherein a piezoelectric thin film is vibrated by applying an alternating voltage to the piezoelectric thin film to discharge or suck air. A piezoelectric blower may be relatively small in size and achieve a stable wind pressure in a shorter period as of the application of a drive voltage as compared to fan blowers. In some examples, the blower 214 may be a fan blower.

The example optical media sensor 200 may include a second guide wall 208 having a second opening 204 facing the first opening 202. The conveyance path 4 is defined between the first guide wall 206 and the second guide wall 208, and the medium sheet 14 may be arranged in the conveyance path 4. Arrangement of the medium sheet 14 in the conveyance path 4 may facilitate guiding of the medium sheet 14 in a predetermined direction, and also enable a more rapid operation to press the medium sheet 14 to the first guide wall 206. The blower 214 may be arranged across the second guide wall 208 outside the conveyance path 4. At the time of detecting the amount of the reflected light, the blower 214 may generate a wind pressure for pressing the medium sheet 14 to the first guide wall 206 through the second opening 204. Arrangement of the blower 214 outside the conveyance path 4 can prevent the conveyance of the medium sheet 14 from being hampered by the blower 214. In some other examples, where the first guide wall 206 below the medium sheet 14 suffices to convey the medium sheet 14 in a selected or predetermined direction, the second guide wall 208 may be omitted.

The optical media sensor 200 may include a sensor housing 216 for accommodating the light emitter 210 and the light receiver 212, and the sensor housing 216 may have a light permeable window 218 facing the first opening 202 of the first guide wall 206. This can protect the light emitter 210 and the light receiver 212 from foreign matters such as dust.

The sensor housing 216 may be disposed at a predetermined distance D1 from the first guide wall 206, and fixed firmly to an installation frame or the like in an apparatus such as an imaging apparatus. Fixing means may be an adhesive or welding, and it may be a mechanical fixture such as a bolt and a nut.

The optical media sensor 200 may include a spacer 220 between the sensor housing 216 and the first guide wall 206. In some examples, with reference to FIGS. 2A and 2B, the spacers 220 having the same length D1 are provided at four comers of a surface of the sensor housing 216, the surface facing the first guide wall 206, and are located on both sides of the first opening 202 when seen in a direction perpendicular to the drawing sheet. The sensor housing 216 may be fixed (e.g., in abutment) against the first guide wall 206 through the spacer 220. This makes it easy to arrange the sensor housing 216 at a predetermined distance D1 from the first guide wall 206, thereby preventing variation in the installation position of the sensor housing 216. Note that the spacer 220 may have any shape as long as it can arrange the sensor housing 216 at the predetermined distance D1 from the first guide wall 206 without hampering an air flow from the blower 214. In some examples, the spacer 220 may include a bezel spacer having a height D1 and located along an outer periphery of a surface, facing the first guide wall 206, of the sensor housing 216. The light emitter 210 is arranged at such a position and an angle in the sensor housing 216 that it emits light at a predetermined distance and angle to the medium sheet 14 pressed to the first guide wall 206 when the sensor housing 216 is arranged at the predetermined distance D1 from the first guide wall 206. Likewise, the light receiver 212 is arranged at such a position and an angle in the sensor housing 216 that it receives reflected light at a predetermined distance and angle from the medium sheet 14 pressed to the first guide wall 206 when the sensor housing 216 is arranged at the predetermined distance D1 from the first guide wall 206.

The optical media sensor 200 may determine surface characteristics of the medium sheet 14 based on the amount of the reflected light detected by the light receiver 212. In some examples, the optical media sensor 200 may control the operation of the light emitter 210, the light receiver 212 and the blower 214. The optical media sensor 200 may include a processor (not illustrated) for determining a surface characteristic of the medium sheet 14 based on the amount of the reflected light detected by the light receiver 212. In some examples, the processor may compare the amount of the reflected light detected by the light receiver 212 with a preset predetermined value to determine the presence or absence of a surface characteristic such as a gloss on the surface of the medium sheet 14. In some examples, the processor may determine that the medium sheet 14 is a sheet having a gloss on its surface (e.g., glossy paper or an OHP sheet) when an amount of regular reflection light detected by the light receiver 212 is equal to or more than a threshold value (e.g., a predetermined value); that is, it may determine the presence of a gloss in terms of the surface characteristic. When the amount of the regular reflection light detected by the light receiver 212 is less than the threshold value, the processor may determine that the medium sheet 14 is a sheet having no gloss on its surface (e.g., plain paper); that is, it may determine the absence of a gloss in terms of the surface characteristic.

FIGS. 2C and 2D illustrate an example self-cleaning function of the example optical media sensor 200 shown in FIGS. 2A and 2B. For better ease of understanding, the light emitter 210, the light receiver 212 and the spacer 220 are not illustrated in FIGS. 2C and 2D. FIG. 2C illustrates a state of the optical media sensor 200, in which foreign matters 222 such as dust have attached to the light permeable window 218. As shown in FIG. 2D, the blower 214 discharges air toward the light permeable window 218 when the light permeable window 218 is not covered by the medium sheet 14. This blows off the foreign matters 222 such as dust attached to the light permeable window 218.

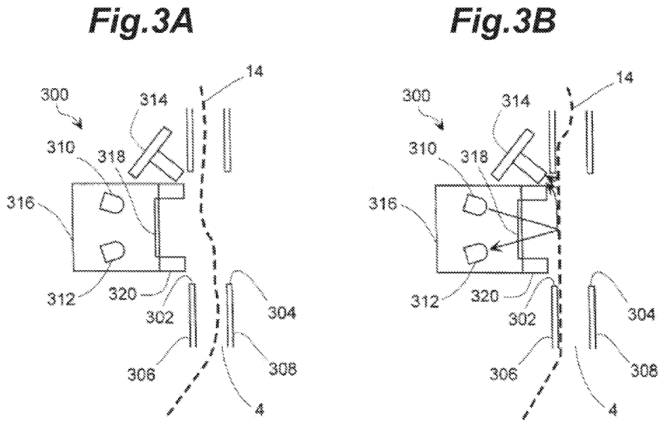

With reference to FIGS. 3A and B, an example optical media sensor 300 includes a blower 314 arranged on the opposite side of a medium sheet 14 relative to a first guide wall 306, and generates a wind pressure for pressing the medium sheet 14 to the first guide wall 306 by a suction operation. In some examples, the optical media sensor 300 may be provided without a self-cleaning function, such as the one illustrated in FIGS. 2C and 2D. The optical media sensor 300 may otherwise have a similar configuration as the optical media sensor 200. In some examples, the optical media sensor 300 may include a light permeable window 318, and a blower similar to the blower 214 shown in FIG. 2C, to clean the light permeable window 318.

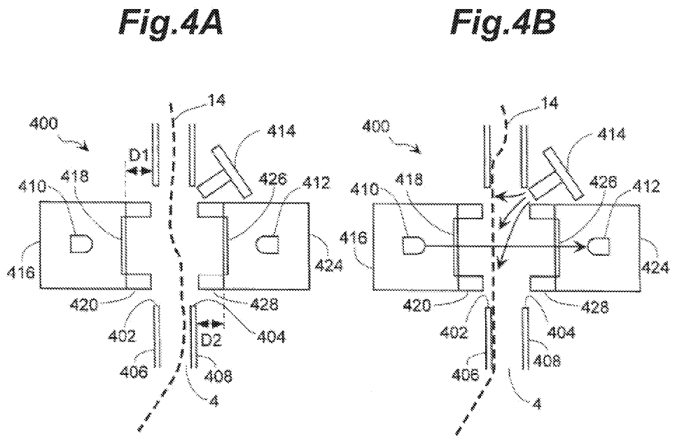

With reference to FIGS. 4A and 4B, an example optical media sensor 400 includes a first guide wall 406 having a first opening 402, a light emitter 410 for emitting light to a medium sheet 14 through the first opening 402, a light receiver 412 for detecting the amount of the transmitted light received from the medium sheet 14, and a blower 414. With reference to FIG. 4A, ata time of non-operation of the optical media sensor 400, the medium sheet 14 may come close to the first guide wall 406 and may be conveyed with a slight deformation. The blower 414 is disposed at the same side as the medium sheet 14 relative to the first guide wall 406 while away from the medium sheet 14. With reference to FIG. 4B, at the time of detecting the amount of the transmitted light, the blower 414 may generate a wind pressure for pressing the medium sheet 14 to the first guide wall 406. The blower 414 may generate this wind pressure by discharge operation. This allows the medium sheet 14 near a detection area to keep its position or shape constant during detection of the amount of the transmitted light, therefore keeping an optical path length and an angle constant. Since this can press the medium sheet 14 to the first guide wall 406 without contacting the medium sheet 14, there is no possibility that the medium sheet 14 is damaged. In some examples, the light emitter 410 may include a light emitting diode (LED) as a light-emitting element. The light emitter 410 may include other light-emitting element. In some examples, the light receiver 412 may include a photodiode (PD) or a phototransistor (PTr) as a light-receiving element. The light receiver 412 may include other light-receiving element.

The blower 414 may generate a wind pressure for pressing the medium sheet 14 to the first guide wall 406. In some examples, the blower 414 may include a piezoelectric blower, also referred to herein as a micro blower, a micro air pump or the like. A piezoelectric blower is a blower wherein a piezoelectric thin film is vibrated by applying an alternating voltage to the piezoelectric thin film to generate a wind pressure. A piezoelectric blower is smaller in size and generates a stable wind pressure within a shorter period of time as of application of a drive voltage, in comparison to a fan blower. In some examples, the blower 414 may be a fan blower.

The optical media sensor 400 may include a second guide wall 408 having a second opening 404 facing the first opening 402. The conveyance path 4 may be defined between the first guide wall 406 and the second guide wall 408, and the medium sheet 14 may be arranged in the conveyance path 4. Arrangement of the medium sheet 14 in the conveyance path 4 may facilitate guiding of the medium sheet 14 in a predetermined direction, and also enable a more rapid operation to press the medium sheet 14 toward the first guide wall 406. The blower 414 is arranged across the second guide wall 408 outside the conveyance path 4; and at the time of detecting the amount of the transmitted light, it may generate a wind pressure for pressing the medium sheet 14 to the first guide wall 406 through the second opening 404. Arrangement of the blower 414 outside the conveyance path 4 can prevent conveyance of the medium sheet 14 from being hampered by the blower 414. In some examples, in the case that the conveyance path 4 has a certain degree of inclination from a direction of gravitational force and arrangement of the first guide wall 406 below the medium sheet 14 is sufficient for the medium sheet 14 to be conveyed in a selected or predetermined direction, the second guide wall 408 may be omitted.

The optical media sensor 400 may include a sensor housing 416 for accommodating the light emitter 410, and the sensor housing 416 may have a light permeable window 418 facing (or aligned with) the first opening 402 of the first guide wall 406, to protect the light emitter 410 from foreign matters such as dust. Similarly, the optical media sensor 400 may include a sensor housing 424 for accommodating the light receiver 412, and the sensor housing 424 may have a light permeable window 426 facing (or aligned with) the second opening 404 of the second guide wall 408. This can protect the light receiver 412 from foreign matters such as dust.

The sensor housing 416 is disposed at a predetermined distance D1 from the first guide wall 406, and fixed firmly to an installation frame or the like in an apparatus such as an imaging apparatus. Similarly, the sensor housing 424 is disposed at a predetermined distance D2 from the second guide wall 408, and fixed firmly to an installation frame or the like in an apparatus such as an imaging apparatus. Fixing means may be an adhesive or welding, and it may be a mechanical fixture such as a bolt and a nut.

The optical media sensor 400 may include a spacer 420 between the sensor housing 416 and the first guide wall 406. In some examples, with reference to FIGS. 4A and 4B, the spacers 420 having the same length D1 are provided respectively, at four corners of a surface of the sensor housing 416, where the surface faces (e.g., or extends toward) the first guide wall 406. The spacers 420 are located on both sides of the first opening 402 when seen in a direction perpendicular to the drawing sheet. The sensor housing 416 may be fixed (e.g., in abutment) against the first guide wall 406 through the spacer 420. This makes it easy to arrange the sensor housing 416 at a predetermined distance D1 from the first guide wall 406, thereby preventing variations in the installation position of the sensor housing 416. Depending on examples, the spacer 420 may be provided in a variety of shapes to locate the sensor housing 416 at the predetermined distance D1 from the first guide wall 406 without hampering an air flow from the blower 414. In some examples, the spacer 420 may include a bezel spacer that has a height D1 and is provided along an outer periphery of a surface facing (or extending toward) the first guide wall 406 of the sensor housing 416. The light emitter 410 may be positioned and angled in the sensor housing 416 to emit light at a predetermined distance and angle (e.g., 90 degrees) to the medium sheet 14 pressed to the first guide wall 406 when the sensor housing 416 is arranged at the predetermined distance D1 from the first guide wall 406.

The optical media sensor 400 may include a spacer 428 between the sensor housing 424 and the second guide wall 408. In some examples, with reference to FIGS. 4A and 4B, spacers 428 having the same length D2 are provided at four corners of a surface of the sensor housing 424, the surface facing the second guide wall 408. The spacers are disposed to be situated on both sides of the second opening 404 when seen in a direction perpendicular to the drawing sheet. The sensor housing 424 may be fixed (e.g., in abutment) against the second guide wall 408 via the spacer 428. Accordingly, the sensor housing 424 may be arranged at a predetermined distance D2 from the second guide wall 408, thereby preventing variation in the installation position of the sensor housing 424. Depending on examples, the spacer 428 may have a variety of shapes to locate the sensor housing 424 at the predetermined distance D2 from the second guide wall 408 without hampering an air flow from the blower 414. In some examples, the spacer 428 may include a bezel spacer that has a height D2 and is provided along an outer periphery of a surface facing the second guide wall 408 of the sensor housing 424. The light receiver 412 may be positioned and angled in the sensor housing 424, to receive light at a predetermined distance and angle (e.g., 90 degrees) to the medium sheet 14 pressed to the first guide wall 406 when the sensor housing 424 is arranged at the predetermined distance D2 from the second guide wall 408.

The example optical media sensor 400 may determine a thickness of the medium sheet 14 based on the amount of the transmitted light detected by the light receiver 412. In some examples, the optical media sensor 400 may control the operation of the light emitter 410, the light receiver 412 and the blower 414. The optical media sensor 400 may include a processor (not illustrated) for determining a thickness of the medium sheet 14 based on the amount of the transmitted light detected by the light receiver 412. In some examples, the processor may determine that the medium sheet 14 is a thick paper when the amount of the transmitted light detected by the light receiver 412 is less than a threshold value (or a predetermined value); and it may determine that the medium sheet 14 is thin paper when the amount of the detected transmitted light is equal to or more than a threshold value (e.g., the predetermined value).

The example optical media sensor 400 may include, in addition to the light emitter 410 and the light receiver 412, the light emitter 210 and the light receiver 212 shown in FIG. 2A. Similarly, the example optical media sensor 200 may include, in addition to the light emitter 210 and the light receiver 212, the light emitter 410 and the light receiver 412 shown in FIG. 4A. Accordingly, the modified optical media sensors 200 and 400 can determine a thickness of the medium sheet 14 based on the amount of the transmitted light, in addition to determining surface characteristics based on the amount of the reflected light. For example, the optical media sensor can determine the type of the medium sheet 14 from the thickness and surface characteristics of the medium sheet 14.

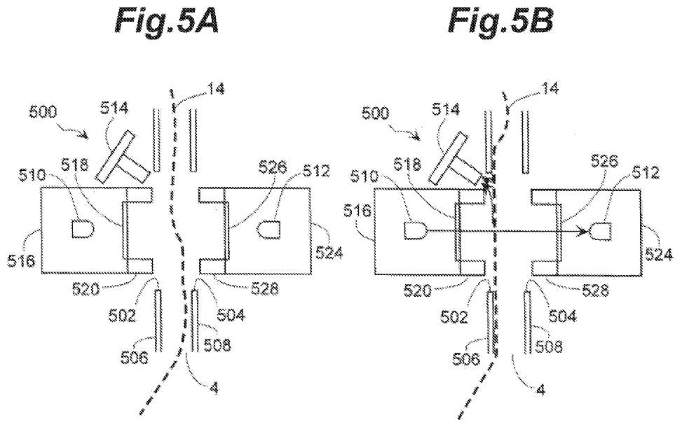

With reference to FIGS. 5A and B, an example optical media sensor 500 may include a blower 514 arranged on the opposite side of a medium sheet 14 relative to a first guide wall 506, to generate a wind pressure for pressing the medium sheet 14 to the first guide wall 506 by a suction operation. The blower 514 has a self-cleaning function, which may be similar to the one described with reference to FIGS. 2C and 2D. For example, the blower 514 may discharge air toward a light permeable window 506 when the medium sheet 14 does not exist. The example optical media sensor 500 may otherwise be arranged similarly to the example optical media sensor 400. In some examples, the optical media sensor 500 may include a blower similar to the blower 214 described with reference to FIGS. 2C and 2D to clean a light permeable window 518 in the optical media sensor 500.

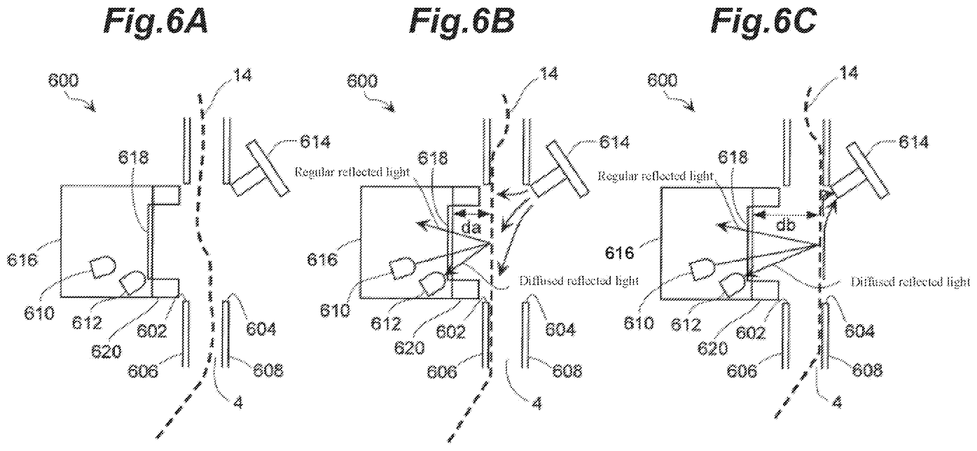

With reference to FIGS. 6A, 6B and 6C, an example optical media sensor 600 may determine a thickness of the medium sheet 14 based on the wind pressure of a blower 614. A light receiver 612 may detect an amount of diffused reflected light received from the medium sheet 14. The blower 614 may generate a wind pressure for moving the medium sheet 14 inside a conveyance path 4 to a first guide wall 606 or a second guide wall 608 through a second opening 604. The optical media sensor 600 may detect the amount of the diffused reflected light from the medium sheet 14 by the light receiver 612 while gradually changing a wind pressure of the blower 614. The optical media sensor 600 may determine a thickness of the medium sheet 14 based on the wind pressures of the blower 614 when the detected amount of the diffused reflected light reaches upper and lower limits, respectively (for example, when the medium sheet 14 comes into contact with each of the first guide wall 606 and the second guide wall 608). The optical media sensor 600 may otherwise be configured similarly to the optical media sensor 200 shown in FIG. 2A. FIG. 6A shows the optical media sensor 600 at the time of non-operation, where the medium sheet 14 is conveyed in the conveyance path 4 between the first guide wall 606 and the second guide wall 608. FIG. 6B shows a discharge operation of the blower 614, where the medium sheet 14 is in contact with the first guide wall 606. FIG. 6C shows a suction operation of the blower 614, where the medium sheet 14 is in contact with the second guide wall 608. In some examples, the position of the blower 614 may be modified to a position similarly to that of the blower 314 shown in FIG. 3A. In such a case, the discharge operation and the suction operation are interchanged in the above explanation.

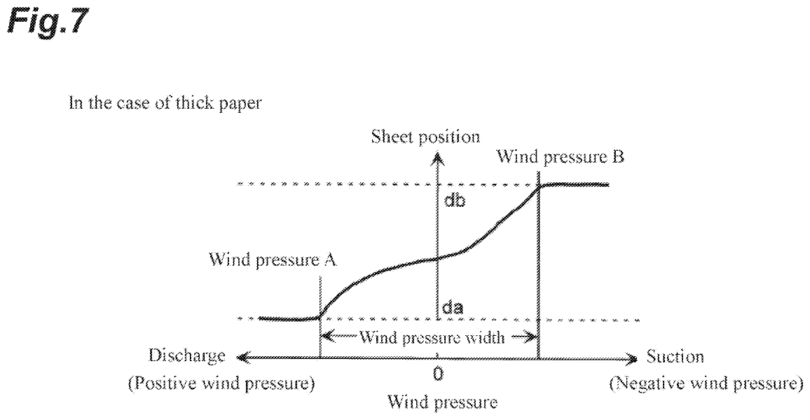

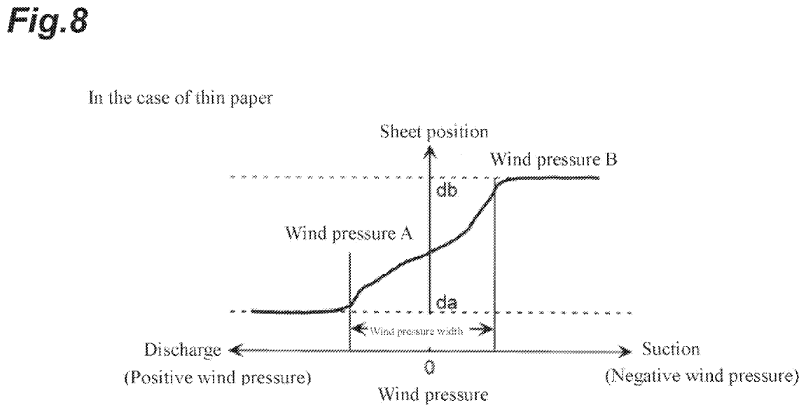

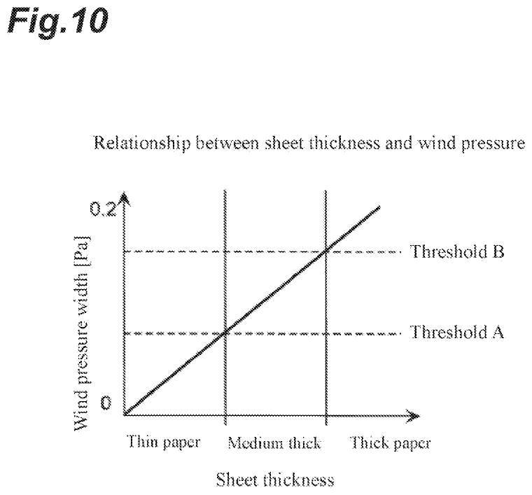

The graph in FIG. 7 illustrates a relationship between the wind pressure of the blower 614 and the position of the medium sheet 14 when the medium sheet 14 is thick paper in the optical media sensor 600. The horizontal axis represents the wind pressure of the blower 614 and the vertical axis represents the position of the medium sheet 14 based on the distance from a sensor housing 616. In the horizontal axis, the wind pressure of “discharge” is represented by a positive value while the wind pressure of “suction” is represented by a negative value. When the wind pressure of the blower 614 is gradually increased in the discharge direction (positive direction) to bring the medium sheet 14 into contact with the first guide wall 606 (FIG. 6B), even a further increase of the wind pressure of the blower 614 would not change the position of the medium sheet 14 from the sheet position “da” (FIG. 6B). The wind pressure of the blower 614 at this timing is referred to as “wind pressure A.” Similarly, when the wind pressure of the blower 614 is gradually increased in the suction direction (negative direction) to bring the medium sheet 14 into contact with the second guide wall 608 (with reference to FIG. 6C), even a further increase of the wind pressure of the blower 614 would not change the position of the medium sheet 14 from the sheet position “db” (FIG. 6C). The wind pressure of the blower 614 at this timing is referred to as “wind pressure B.” In this specification, a difference between wind pressure A and wind pressure B (A−B) (that is a variation of wind pressure) may be referred to as “wind pressure width.” The graph in FIG. 8 illustrates a relationship between the wind pressure of the blower 614 and the position of the medium sheet 14 in the same scale as above when the medium sheet 14 is a thin paper. The graphs of FIG. 7 and FIG. 8 show that when the medium sheet 14 is thick paper, the wind pressure width is larger than when the medium sheet 14 is thin paper. The relationship between the thickness of the medium sheet 14 and the wind pressure width will be explained below with reference to FIG. 10.

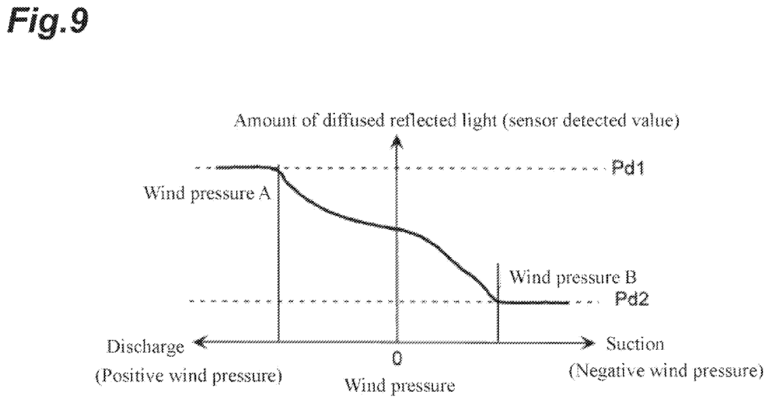

The graph in FIG. 9 illustrates a relationship between the wind pressure of the blower 614 and the amount of the diffused reflected light (sensor-detected value) from the medium sheet 14 in the optical media sensor 600. As described above, when the wind pressure of the blower 614 is gradually increased in the discharge direction (positive direction) to move the medium sheet 14 to the sheet position da, even a further increase of the wind pressure of the blower 614 would not change the position of the medium sheet 14 from the sheet position da. Thus, the amount of the diffused reflected light received from the sheet medium 14 at this timing is not changed from the upper limit Pd1 as shown in the graph of FIG. 9. Similarly, when the wind pressure of the blower 614 is gradually increased in the suction direction (negative direction) to move the medium sheet 14 to the sheet position db, even a further increase of the wind pressure of the blower 614 would not change the position of the medium sheet 14 from the sheet position db. Thus, the amount of the diffused reflected light received from the sheet medium 14 at this timing is not changed from the lower limit Pd2 as shown in the graph of FIG. 9. For example, in the optical media sensor 600, whether or not the medium sheet 14 reaches the sheet position da can be determined based on whether or not the amount of the diffused reflected light received from the medium sheet 14 reaches the upper limit Pd1; and whether or not the medium sheet reaches the sheet position db can be determined based on whether or not the amount of the diffused reflected light received from the medium sheet 14 reaches the lower limit Pd2.

The graph of FIG. 10 illustrates a relationship between a sheet thickness of the medium sheet 14 and a wind pressure width in the optical media sensor 600. As shown in the figure, the sheet thickness of the medium sheet 14 is proportional to the wind pressure width. Thus, the optical media sensor 600 detects the amount of the diffused reflected light from the medium sheet 14 by the light receiver 612 while gradually changing a wind pressure of the blower 614. The optical media sensor 600 calculates a wind pressure width (A−B) from wind pressures A and B of the blower 614 when the amount of the diffused reflected light received from the medium sheet 14 reaches upper and lower limits, respectively. For example, the medium sheet 14 is brought into contact with each of the first guide wall 606 and the second guide wall 608. The optical media sensor 600 compares the wind pressure width with various threshold values to determine a thickness of the medium sheet 14. In some examples, if the wind pressure with is less than a threshold value A, the optical media sensor 600 may determine that the medium sheet 14 is a thin paper, if the wind pressure width is equal to or more than the threshold A and less than a threshold B, the medium sheet 14 may be determined as medium thickness paper, and if the wind pressure width is equal to or more than the threshold B, the medium sheet 14 may be determined as thick paper. The number of thresholds may be one, and it may be three or more, depending on examples. In addition, a specific value of threshold may be determined in various manners depending on the use of an apparatus, into which the optical media sensor 600 is incorporated.

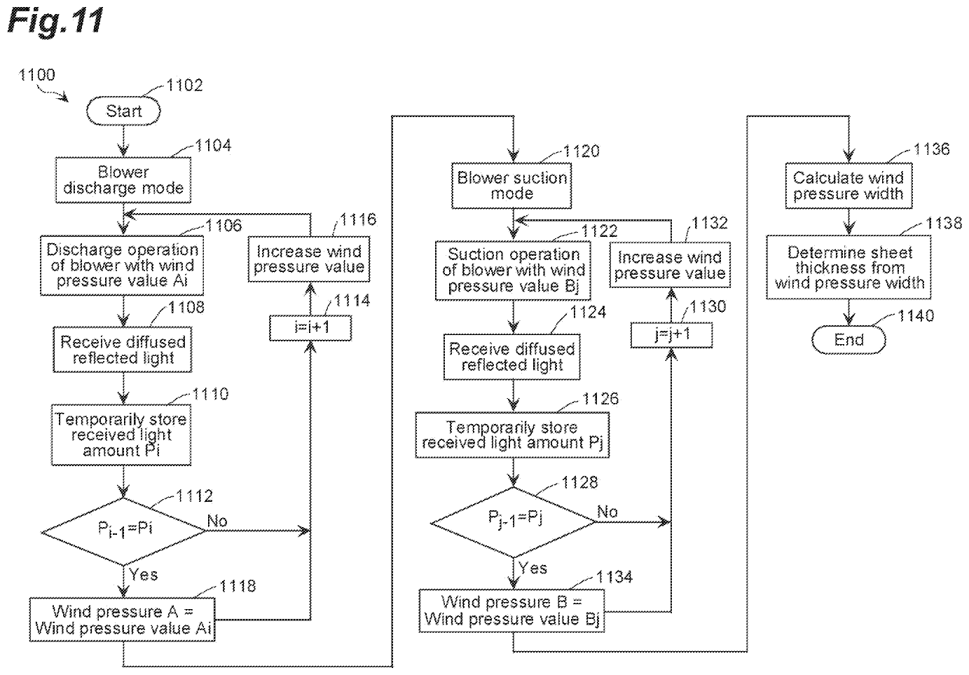

FIG. 11 is a flow chart showing an example process 1100 for determining a thickness of the medium sheet 14 using the example optical media sensor 600. Before the start of process 1100, the medium sheet 14 may be conveyed in an arbitrary position between the first guide wall 606 and the second guide wall 608 with a slight deformation. The example process 1100 may begin at block 1102. At block 1104, the blower 614 is set to a discharge mode and the variable i is initialized to 0 (i=0). At block 1106, the blower 614 is performed in a discharge operation with a wind pressure value of Aᵢ. Note that a first wind pressure value A₀ is set as a wind pressure value d determined by adding a predetermined incremental amount d to a wind pressure value 0. At block 1108, the light emitter 610 emits light to the medium sheet 14 and the light receiver 612 detects the amount of the diffused reflected light received from the medium sheet 14. At block 1110, the detected amount of the diffused reflected light is temporarily stored as a current received amount of light Pᵢ. At block 1112, the current received amount of light Pᵢ is compared to a previous received amount of light P_{i-1.} When Pᵢ is not equal to Pᵢ₋₁, the variable i is incremented at block 1114; and at block 1116, the value obtained by adding a predetermined incremental amount d to a previous wind pressure value Aᵢ₋₁ is determined as a current wind pressure value Aᵢ. Thereafter, the process returns to block 1106. At block 1112, when Pᵢ is equal to Pᵢ₋₁, the process 1100 proceeds to block 1118, where the current wind pressure Aᵢ is determined as a wind pressure A. Then, the process proceeds to block 1120.

At block 1120, the blower 614 is set to a suction mode, and the variable j is initialized to 0 (j=0). At block 1122, the blower 614 is performed in a suction operation with a wind pressure value of Bⱼ. Note that a first wind pressure value B₀ is set as a wind pressure value d determined by adding a predetermined incremental amount d to a wind pressure value 0. At block 1124, the light emitter 610 emits light to the medium sheet 14 and the light receiver 612 detects the amount of the diffused reflected light received from the medium sheet 14. At block 1126, the detected amount of the diffused reflected light is temporarily stored as a current received amount of light Pⱼ. At block 1128, the current received amount of light Pⱼ is compared to a previous received amount of light Pⱼ₋₁. When Pⱼ is not equal to Pⱼ₋₁, the variable j is incremented at block 1130; and at block 1132, the value obtained by adding a predetermined incremental amount d to a previous wind pressure value Bⱼ₋₁ is determined as a current wind pressure value Bⱼ. Thereafter, the process returns to block 1122. At block 1128, when Pⱼ is equal to Pⱼ₋₁, the process 1100 proceeds to block 1134, where the current wind pressure Bⱼ is determined as a wind pressure B. Then, the process proceeds to block 1136, where a difference between the wind pressure A and the wind pressure B is calculated as a wind pressure width. Finally, at block 1138, the wind pressure width is compared with various threshold values, thereby determining a thickness of the medium sheet 14. Block 1140 represents the end of the process 1100. In order to temporarily store the wind pressure values Pᵢ and Pⱼ, the optical media sensor 600 may include a memory (illustration is omitted).

As another example, a processing for determining a wind pressure A (blocks 1104 to 1118) and a processing for determining a wind pressure B (blocks 1120 to 1134) are carried out selectively a plurality of times. A plurality of thus-obtained wind pressure values Aᵢ are averaged, and the resultant average value is determined as the wind pressure A. A plurality of thus-obtained wind pressure values Bⱼ are averaged, and the resultant average value is determined as the wind pressure B. This enables a more accurate measurement of a wind pressure width, therefore enabling a more accurate determination in the thickness of the medium sheet 14.

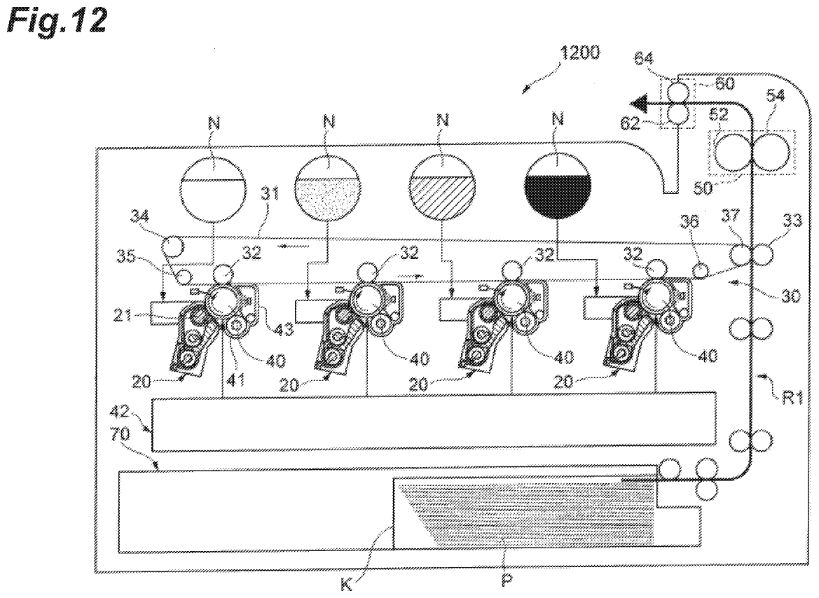

FIG. 12 is a schematic view showing an example imaging apparatus 1200, which can implement an example optical media sensor. The imaging apparatus 1200 includes a toner bottle N, a developing device 20, a photosensitive drum 40, a charging roller 41, and a cleaning unit 43 for each of four toner colors (magenta, yellow, cyan, and black). The imaging apparatus may 1200 include a recording medium conveyance unit 70, a transfer device 30, an exposure unit 42, a fixing device 50, and a discharge device 60. The transfer device 30 may include: an intermediate transfer belt 31; suspending rollers 34, 35, 36 and 37, which suspend the intermediate transfer roller 31 for enabling rotational motion; four primary transfer rollers 32 associated with the respective photosensitive drums 40; and a secondary transfer roller 33, which rotates by following the motion of the intermediate transfer belt 31 while pressing a paper sheet P to the intermediate transfer belt 31. The suspending roller 37 is configured as a drive roller for allowing the intermediate transfer belt 31 to circulate in a direction indicated by arrows.

In the imaging apparatus 1200, each photosensitive drum 40 may be charged by way of a corresponding charging roller 41, forming an electrostatic latent image thereon by the exposure unit 42 in accordance with image data of a corresponding color. A corresponding developing device 20 may develop the electrostatic latent image with a toner from a corresponding toner tank N to form a toner image. Four color toner images formed on the respective four photosensitive drums 40 are sequentially layered or superimposed on the intermediate transfer belt 31 by the primary transfer rollers 32 to form a single composite toner image. The toner image formed on the intermediate transfer belt 31 is transferred on the paper sheet P by the secondary transfer roller 33, and fixed on the paper sheet P by the fixing device 50 which includes a heating roller 52 and a pressing roller 54. The paper sheet P is conveyed one at a time along a conveyance path R1 from a cassette K by the recording medium conveyance unit 70. The toner image is transferred onto the conveyance path R1 by the secondary transfer roller 33. The paper sheet is discharged by the discharge device 60 including discharging rollers 62, 64.

Optical media sensors according to the various examples described herein are each disposed near the conveyance path R1 in the imaging apparatus 1200, thus enabling detection of surface characteristics or a thickness of a paper sheet P passing through the conveyance path R1. Optical media sensors according to various examples may be implemented in other imaging apparatus.

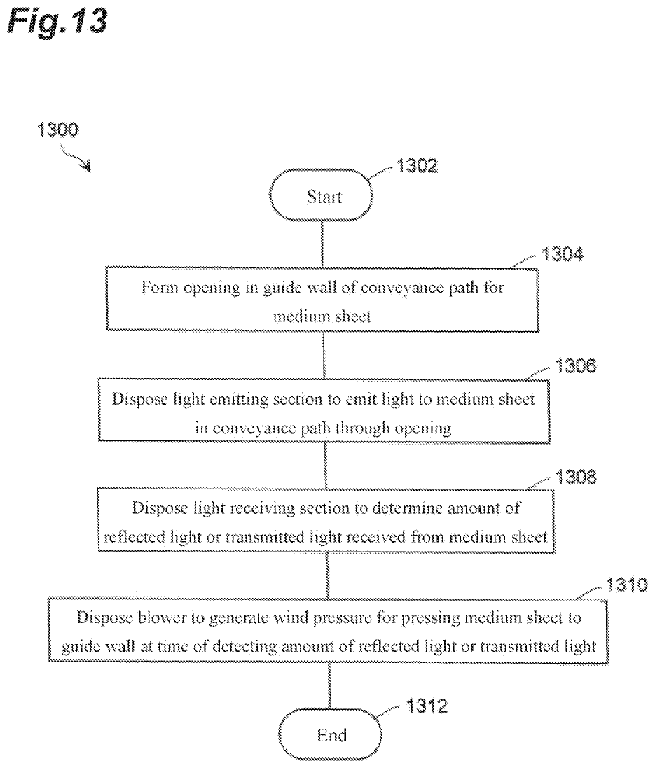

FIG. 13 is a flow chart showing an example manufacturing method 1300 of an optical media sensor, starting at block 1302. At block 1304, an opening is formed in a guide wall of a conveyance path for a medium sheet. At block 1306, a light emitter is disposed, for emitting light to the medium sheet in the conveyance path through the opening. At block 1308, a light receiver is disposed, for detecting the amount of the reflected light or the transmitted light received by the medium sheet. At block 1310, a blower is disposed, for generating a wind pressure to press the medium sheet to the guide wall at the time of detecting the amount of the reflected light or the transmitted light. The block 1312 represents the end of the manufacturing method 1300. The blower may be a piezoelectric blower.

It is to be understood that not all aspects, advantages and features described herein may necessarily be achieved by, or included in, any one particular example. Indeed, having described and illustrated various examples herein, it should be apparent that other examples may be modified in arrangement and detail.

1. An optical media sensor comprising:
a guide wall having an opening;
a light emitter to emit light to a medium sheet through the opening;
a light receiver to detect an amount of light travelling from the medium sheet; and
a blower to generate a wind pressure to press the medium sheet against the guide wall when the light receiver detects the amount of light.

2. The optical media sensor according to claim 1, the blower to generate the wind pressure by at least one operation selected from the group consisting of a discharge operation and a suction operation.

3. The optical media sensor according to claim 1, wherein the blower is a piezoelectric blower.

4. The optical media sensor according to claim 1, wherein the light receiver is located adjacent the light emitter to receive a reflected light from the medium sheet through the opening in the guide wall.

5. The media sensor according to claim 5, wherein the blower is located adjacent the opening and outside the conveyance path, to generate the wind pressure through the opening.

6. The optical media sensor according to claim 1,
wherein the guide wall is a first guide wall,
wherein the optical media sensor comprises a second guide wall opposite the first guide wall, and
wherein a conveyance path is defined between the first guide wall and the second guide wall to convey the medium sheet.

7. The optical media sensor according to claim 6, wherein the opening in the first guide wall is a first opening, and wherein the second wall comprises a second opening.

8. The media sensor according to claim 7, wherein the blower is located adjacent the second opening outside the conveyance path to generate the wind pressure through the second opening.

9. The media sensor according to claim 7, wherein the light receiver is located adjacent the second opening to receive a transmitted light having travelled through the medium sheet.

10. The optical media sensor according to claim 7,
the light receiver to detect an amount of diffused reflected light travelling from the medium sheet, and
the blower to generate a varying wind pressure to move the medium sheet in the conveyance path,
wherein the optical media sensor comprises a controller to:
detect the amount of the diffused reflected light from the medium sheet by the light receiver while the blower gradually changes the wind pressure, and
determine a thickness of the medium sheet based on different wind pressures generated by the blower when the detected amount of the diffused reflected light reaches upper and lower limits, respectively.

11. The optical media sensor according to claim 10, the blower to generate the varying wind pressures to move the medium sheet in the conveyance path selectively toward the first guide wall and toward the second guide wall, through the first opening or the second opening.

12. The optical media sensor according to claim 1, comprising a sensor housing to accommodate at least one device selected from the group consisting of the light emitter and the light receiver,
wherein the sensor housing has a light permeable window adjacent the opening of the guide wall,
the blower to discharge air toward the light permeable window when the medium sheet is absent.

13. The optical media sensor according to claim 12, wherein:
at least one device selected from the group of the light emitter and the light receiver, is disposed at a predetermined position in the sensor housing; and
the optical media sensor comprises a spacer between the sensor housing and the guide wall.

14. The optical media sensor according to claim 1,
the light receiver to detect an amount of reflected light travelling from the medium sheet,
wherein the optical media sensor comprises a controller to determine a surface characteristic of the medium sheet based on the detected amount of the reflected light.

15. The optical media sensor according to claim 1,
the light receiver to detect an amount of transmitted light travelling from the medium sheet,
wherein the optical media sensor comprises a controller to determine a thickness of the medium sheet based on the detected amount of the transmitted light.
